(19) United States
(12) Patent Application Publication
(10) Pub. No.: US 2025/0055167 A1
(43) Pub. Date: Feb. 13, 2025

(54) BATTERY CELL AND BATTERY CELL STACK

(71) Applicant: Toyota Jidosha Kabushiki Kaisha, Toyota-shi (JP)

(72) Inventors: Yusuke IKEDA, Miyoshi-shi (JP); Kenichi Kakishita, Nagoya-shi (JP); Tomofumi Hirukawa, Miyoshi-shi (JP); Masashi Ueda, Toyota-shi (JP); Shinji Kojima, Nagoya-shi (JP); Masataka Ogushi, Nisshin-shi (JP); Kosuke Yonekawa, Nisshin-shi (JP)

(73) Assignee: Toyota Jidosha Kabushiki Kaisha, Toyota-shi (JP)

(21) Appl. No.: 18/645,804

(22) Filed: Apr. 25, 2024

(30) Foreign Application Priority Data
Aug. 9, 2023 (JP) 2023-130505

(51) Int. Cl. H01M 50/595; H01M 10/04

(52) U.S. Cl. CPC H01M 50/595; H01M 10/0431

(57) ABSTRACT

A battery cell includes an electrode body in which a plurality of laminated structures having a cathode, an anode, and a separator interposed between the cathode and the anode are further laminated, and a tape wound around the outer periphery of the electrode body over one circumference, wherein the tape has an overlapping portion in which one side and the other end side in an outer peripheral direction overlap each other, and a direction in which a plurality of laminated structures are laminated in the electrode body is defined as a lamination direction, and in a case where an end surface in a lamination direction in the electrode body is defined as a lamination surface, the overlapping portion is disposed on a surface other than the lamination surface in the electrode body.

### CROSS-REFERENCE TO RELATED APPLICATION

This application claims priority to Japanese Patent Application No. 2023-130505 filed on Aug. 9, 2023, incorporated herein by reference in its entirety.

### BACKGROUND

### 1. Technical Field

The present disclosure relates to a battery cell and a battery cell stack.

### 2. Description of Related Art

A battery cell in which an electrode body in which a plurality of cathodes, anodes, and separators are laminated, is bundled by tape has been conventionally studied.

For example, Japanese Unexamined Patent Application Publication No. 2016-015212 (JP 2016-015212 A) discloses a secondary battery including a laminate in which cathodes and anodes are alternately laminated via separators, and tape for fixing the laminate, in which the tape has a pair of flat sticking portions provided at each end portion thereof and each stuck to both outermost layers of the laminate, and an intermediate portion situated between the pair of flat sticking portions and attached to a side edge of each layer of the laminate, and the flat sticking portions have tapered shapes with an acute angle at distal ends thereof.

Further, in Japanese Unexamined Patent Application Publication (Translation of PCT Application) No. 2015-534251 (JP 2015-534251 A), an electrode body is disclosed that includes a first electrode laminate in which at least one electrode unit having a first area is laminated, and a second electrode laminate in which at least one electrode unit having a second area that is different from the first area is laminated, the first electrode laminate and the second electrode laminate are stacked in a direction perpendicular to a flat plane, and the first electrode laminate and the second electrode laminate have a stepped portion formed by a difference in area therebetween, in which the stepped portion is present on at least one side of four sides of the electrode body, at least one stepped portion has at least one tape that is taped traversing a stacking side face, and the tape has a stepped shape of the stepped portion.

### SUMMARY

Now, when tape is wound one round around an outer perimeter of an electrode body in a battery cell and applied thereto, an overlapping portion is formed in which one end side and the other end side of the tape overlap each other in an outer perimeter direction. A plurality of the battery cells are used by being stacked together with other battery cells in a stacking direction, and accordingly, when the overlapping portions of the tape are all disposed on the end face (stacking face) in the stacking direction of the electrode body, for example, the volume in the stacking direction increases due to the overlapping portions of the tape, and as a result, volume efficiency decreases. In other words, in a form in which tape is wound one round around an outer perimeter of an electrode body and applied thereto, and an overlapping portion is formed in which one end side and the other end side of the tape overlap each other, there remains room for further increase in volume efficiency.

The present disclosure has been made in view of the above circumstances, and an object thereof is to provide a battery cell with increased volume efficiency, and a battery cell stack including the battery cell.

Means for addressing the above problem include the following aspects.
1. A battery cell includes an electrode body, in which is stacked a plurality of laminated structures, each of the laminated structures including a cathode, an anode, and a separator interposed between the cathode and the anode, and
tape that is wound one round around an outer perimeter of the electrode body and applied.
   The tape includes an overlapping portion at which one end side and another end side in an outer perimeter direction overlap, and
with a direction in which the laminated structures are stacked in the electrode body as a stacking direction, and an end face in the stacking direction in the electrode body as a stacking face,
the overlapping portion is disposed on a face of the electrode body other than the stacking face.
2. The battery cell according to 1, in which a plurality of pieces of the tape may be wound and applied to the outer perimeter of the electrode body, and the overlapping portions of all of the pieces of tape may be disposed on a face of the electrode body other than the stacking face.
3. The battery cell according to 2, in which the overlapping portions of all of the pieces of tape may be disposed on a same one face of the faces of the electrode body, other than the stacking face.
4. A battery cell stack includes a plurality of the battery cells according to any one of 1 to 3, stacked in the stacking direction.

According to the present disclosure, a battery cell with increased volume efficiency, and a battery cell stack including the battery cell, can be provided.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic perspective view illustrating the battery cell concerning the embodiment of this disclosure;

FIG. 2 is a schematic cross sectional view illustrating the battery cell of another mode concerning the embodiment of this disclosure;

FIG. 3 is a schematic view of a battery cell accommodated in a battery module as viewed from a thickness direction;

FIG. 4 is a schematic plan view showing a main part of a vehicle;

FIG. 5 is a schematic perspective view of a cell module; and

FIG. 6 is a plan view of the battery module with the upper lid removed.

### DETAILED DESCRIPTION OF EMBODIMENTS

### Battery Cell

A battery cell according to an embodiment of the present disclosure includes an electrode body in which a plurality of laminated structures including a cathode, an anode, and a separator interposed between the cathode and the anode are further laminated, and a tape wound around the outer periphery of the electrode body and attached. The tape has an overlapping portion in which one side and the other end side in the outer circumferential direction overlap each other.

When a direction in which a plurality of stacked structures is stacked in the electrode body is defined as a stacking direction and a surface orthogonal to the stacking direction in the electrode body is defined as a stacking surface, an overlapping portion is disposed on a surface other than the stacking surface in the electrode body.

Hereinafter, an embodiment of a battery cell according to an embodiment of the present disclosure will be described with reference to the drawings.

Each drawing shown below is schematically shown, and the size and shape of each part are appropriately exaggerated for easy understanding.

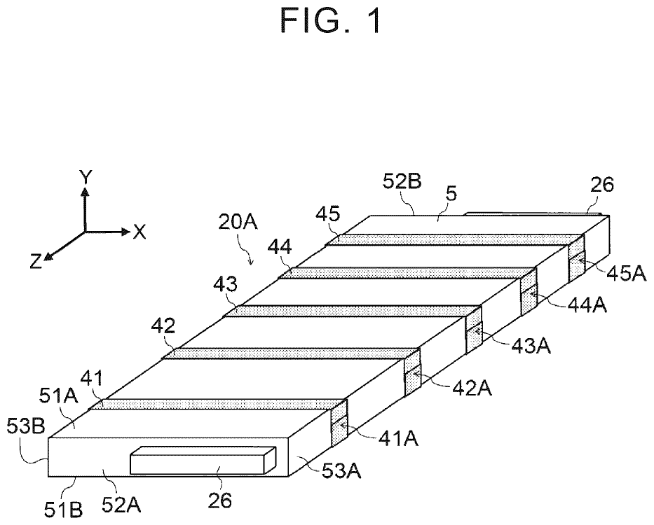

FIG. 1 is a schematic perspective view illustrating a battery cell according to an embodiment of the present disclosure.

The battery cell 20A shown in FIG. 1 includes an electrode body 5 formed in a substantially rectangular plate shape. Although not shown, the electrode body 5 further includes a plurality of stacked structures including a cathode, an anode, and a separator interposed between the cathode and the anode, in the direction of arrow Y (stacking direction).

In FIG. 1, the thickness direction of the electrode body 5 (that is, the stacking direction) is defined as an arrow Y direction, the longitudinal direction of the electrode body 5 is defined as an arrow Z direction, and the lateral direction of the electrode body 5 is defined as an arrow X direction. The arrow X direction, the arrow Y direction, and the arrow Z direction are mutually orthogonal relationships. In addition, both end faces in the stacking direction (arrow Y direction) of the electrode body 5 are set as the stacking surface 51A, 51B, both end faces in the longitudinal direction (arrow Z direction) of the electrode body 5 are set as the longitudinal side surface 52A, 52B, and both end faces in the lateral direction (arrow X direction) of the electrode body 5 are set as the lateral side surface 53A, 53B.

The electrode body 5 has terminals (tabs) 26 on each of the longitudinal side surface 52A, 52B. In the present embodiment, as an example, the terminal 26 is provided at a position offset from the center of the battery cell 20 in the short-side direction (arrow X direction) to one side.

Five tapes 41 to 45 are arranged on the outer periphery of the electrode body 5 so as to be wound around the entire circumference. Each of the tapes 41 to 45 is wound around the stacking surface 51A, 51B and the lateral side surface 53A, 53B of the electrode body 5 over the entire circumference. In the electrode body 5, the outer periphery is wound with tapes 41 to 45, so that a laminated structure including a cathode, an anode, and a separator is bundled. Each of the tapes 41 to 45 is wound around the electrode body 5 so that the side and the other end side thereof are overlapped with each other, and a 45A is formed from the overlapping portion 41A in which both ends are overlapped with each other. Each of the overlapping portions 41A to 45A is disposed on a surface other than the stacking surface 51A, 51B of the electrode body 5, specifically, on the lateral side surface 53A.

As described above, the battery cell according to the embodiment of the present disclosure has one or more tapes wound around the outer periphery of the electrode body over one circumference, and in at least one of the tapes, the overlapping portion is disposed on a surface other than the lamination surface of the electrode body. The battery cell according to the embodiment of the present disclosure is further used by being stacked together with a plurality of battery cells in a stacking direction (for example, an arrow Y direction in FIG. 1). Therefore, when one or more of the overlapping portions of the tape is disposed on a surface other than the stacked surface of the electrode body, the number of overlapping portions disposed on the stacked surface is reduced, and a higher surface pressure is applied from the stacked battery cells to the overlapping portions disposed on the stacked surface to be easily crushed. As a result, the volume in the stacking direction due to the overlapping portion of the tapes can be reduced, the space in the stacking direction can be effectively used, and the volume efficiency is improved.

In FIG. 1, all of the overlapping portions 41A to 45A of the five tapes 41 to 45 are arranged on a surface other than the stacking surface 51A, 51B of the electrode body 5, but the present disclosure is not limited thereto. In the case where a plurality of tapes is wound around the outer periphery of the electrode body, the overlapping portion of at least one of the tapes may be disposed on a surface other than the lamination surface of the electrode body.

However, when a plurality of tapes are wound around the outer periphery of the electrode body, as in the embodiment shown in FIG. 1, it is preferable that the overlapping portion of all the tapes is disposed on a surface other than the lamination surface of the electrode body (for example, the stacking surface 51A, 51B in FIG. 1). By disposing all the overlapping portions of the plurality of tapes on the surface other than the lamination surface of the electrode body, the overlapping portions arranged on the lamination surface are eliminated, and the volume in the lamination direction by the tape can be further reduced. As a result, the space in the stacking direction can be used more effectively, and the volume efficiency is further improved.

Although FIG. 1 illustrates an embodiment in which all of the overlapping portions 41A to 45A of the five tapes 41 to 45 are disposed on one and the same surface (specifically, on the lateral side surface 53A) of the electrode body 5, the present disclosure is not limited thereto. In the case where a plurality of tapes is wound around the outer periphery of the electrode body, the overlapping portions of the tapes may be disposed on different surfaces. For example, in the embodiment illustrated in FIG. 1, among 45A from the overlapping portions 41A of the five tapes 41 to 45, the overlapping portions of 1 or more and 4 or less may be disposed not on the lateral side surface 53A but on the lateral side surface 53B.

However, in the case where a plurality of tapes is wound around the outer periphery of the electrode body, as in the embodiment shown in FIG. 1, it is preferable that the overlapping portions of all the tapes are arranged on the same surface of one of the surfaces other than the laminated surface of the electrode body. By disposing all the overlapping portions of the plurality of tapes on one and the same surface other than the laminated surface of the electrode body, the overlapping portions disposed on the other surface of the surfaces other than the laminated surface are eliminated (for example, in the embodiment shown in FIG. 1, the overlapping portions disposed on the lateral side surface 53B are eliminated). As a result, it is possible to effectively utilize the space of the surface on the side where the overlapping portion of the tape does not exist. For example, the space can be effectively utilized by securing a space in which another member such as a coolant or a buffer is provided on the surface of the side where the overlapping portion of the tape is not present, and increasing the volume of the electrode body (for example, increasing the length of the electrode body 5 in the lateral direction in the embodiment shown in FIG. 1).

In FIG. 1, the tapes 41 to 45 are wound around the stacking surface 51A, 51B of the electrode body 5 and the lateral side surface 53A, 53B in the lateral direction over the entire circumference, that is, wound around the electrode body 5 in the lateral direction (arrow X direction), but the present disclosure is not limited thereto. For example, the tape may be wound in the longitudinal direction of the electrode body (for example, in the longitudinal direction of the electrode body 5 in FIG. 1 (arrow Z direction)).

For example, in the embodiment shown in FIG. 1, the tape may be wound around the stacking surface 51A, 51B and the longitudinal side surface 52A, 52B of the electrode body 5. In this embodiment, one or more tapes are wound around the outer periphery of the electrode body 5 around one circumference, and in at least one of the tapes, the overlapping portion is disposed on a surface other than the lamination surface of the electrode body 5, that is, on the longitudinal side surface 52A, 52B.

In the case where the electrode has a terminal, for example, as in the embodiment shown in FIG. 1, the terminal is preferably disposed on a surface on which the tape is not wound.

### Laminate Film

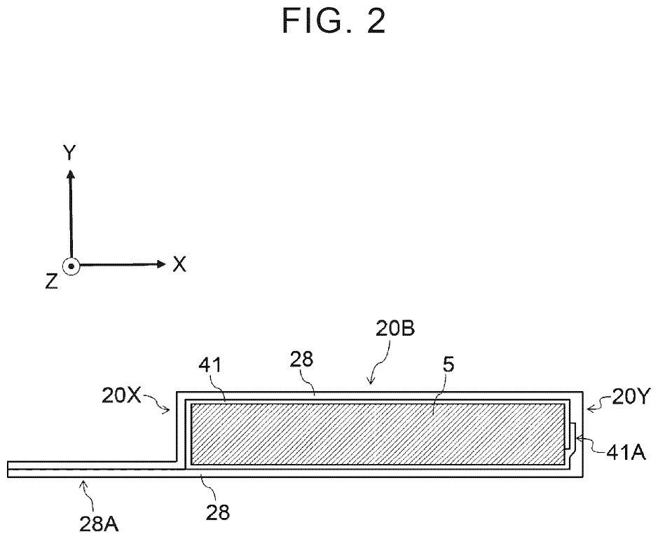

The battery cell according to the embodiment of the present disclosure may be further covered with a laminate film and encapsulated. Here, a battery cell in which the electrode body and the tape having the configuration shown in FIG. 1 are further encapsulated in a laminate film will be described with reference to FIG. 2.

FIG. 2 is a schematic cross-sectional view illustrating a battery cell according to another embodiment of the present disclosure.

The battery cell 20B shown in FIG. 2 has a configuration in which the electrode body 5 having the configuration shown in FIG. 1 and five tapes 41 to 45 (only the tape 41 is shown in FIG. 2) are enclosed in a laminate film 28. Since the electrode body 5 and the five tapes 41 to 45 have the same configuration as in FIG. 1, description thereof will be omitted.

The laminate film 28 forms an accommodation portion of the electrode body 5 by folding and bonding the embossed sheet-like laminate film 28. The laminate film 28 is formed with a scaling portion 28A in which the side and the other end side are temporarily bonded and sealed. The laminate film 28 employs a single-cup embossing structure in which embossing is performed at one place. It is also possible to adopt a double cup embossing structure in which embossing is performed at two places.

Here, the surface of the laminate film 28 on the side where the sealing portion 28A is formed is defined as a surface 20X on the seal portion side, and the surface on the side facing the surface 20X on the seal portion side is defined as an opposing surface 20Y. The overlapping portion 41A of the tape 41 is formed on the opposing surface 20Y side of the laminate film 28, and from the overlapping portion 42A of the tapes 42 to 45 omitted in FIG. 2, 45A is also formed on the opposing surface 20Y side of the laminate film 28. In other words, no 45A is formed on the surface 20X of the laminate film 28 on the sealing portion side from the overlapping portion 41A of the tapes 41 to 45.

As shown in FIG. 2, the battery cell according to the embodiment of the present disclosure has one or more tapes wound around the outer periphery of the electrode body around one circumference, and has one sealing portion in which the electrode body and the tape are sealed to the laminate film and the one side and the other end side of the laminate film are bonded and sealed (hereinafter, simply referred to as “specific mode”). In this particular embodiment, as shown in FIG. 2, it is preferable that the overlapping portion of the tape is not disposed at a position in contact with the surface of the laminate film on which the seal portion is formed. When the seal portion of the laminate film is formed (for example, when the seal portion is formed by welding), if irregularities exist in the vicinity of the region where the seal portion is formed, wrinkles may occur in the seal portion. On the other hand, since there is no overlapping portion of the tape at a position in contact with the surface on which the seal portion is formed, it is possible to suppress the occurrence of wrinkles that occur when forming the seal portion of the laminate film.

On the other hand, in the above-described particular aspect, the overlapping portion of the tape may not be disposed at a position in contact with a surface (for example, the opposing surface 20Y in FIG. 2) of the laminated film facing the surface on which the sealing portion is formed. In this case, the electrode body on the opposite surface (the opposing surface 20Y in FIG. 2) and the laminated film have a short distance. Therefore, the electrode body is excellent in coolability.

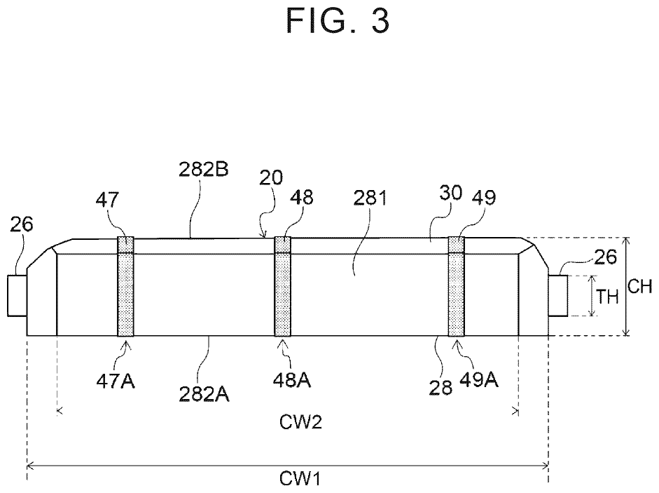

Although FIG. 2 illustrates an embodiment in which the tapes 41 to 45 are wrapped around and affixed to the surface of the electrode body 5 and the electrode bodies 5 and the tapes 41 to 45 are encapsulated in the laminate film 28, the present disclosure is not limited thereto. For example, the tape may be wrapped on the outer surface of the laminate film. Here, a battery cell in which a tape is wound on an outer surface of a laminate film will be described with reference to FIG. 3.

As shown in FIG. 3, the battery cell 20 is formed in a substantially rectangular plate shape, and an electrode body (not shown) is accommodated therein and sealed by a laminate film 28. Three tapes 47 to 49 are arranged on the outer periphery of the laminate film 28 so as to be wound around the entire circumference. Each of the tapes 47 to 49 is wound around the laminated surface (the surface 281 in FIG. 3 and the surface on the back side of the surface 281) of the electrode body encapsulated in the laminate film 28 and around the lateral side surface 282A, 282B. Each of the tapes 47 to 49 is wound so that the outer circumferential side and the other end side of the laminate film 28 overlap each other, and a 49A is formed from the overlapping portion 47A in which both ends overlap each other. All of the overlapping portions 47A to 49A are disposed on a surface other than the laminated surface (the surface 281 and the surface on the back side of the surface 281) of the electrode body 5 encapsulated in the laminate film 28, specifically, on the lateral side surface 282A.

In the battery cell of the aspect in which the tape is wound on the outer surface of the laminate film, the overlapping portion is disposed on the surface of the electrode body sealed in the laminate film other than the lamination surface, whereby the space in the lamination direction can be effectively used, and the volume efficiency is improved.

### Battery Cell Stack

The battery cell according to the embodiment of the present disclosure is used, for example, as a battery cell stack in which a plurality of battery cells is stacked in the stacking direction. In a battery cell stack in which a plurality of battery cells is stacked, it is sufficient that one or more overlapping portions of tape are disposed on at least a surface of each battery cell other than the stacked surface of the electrode body.
However, in the case where a plurality of tapes is wound around the outer periphery of each of the electrode bodies, it is preferable that the overlapping portions of all the tapes are disposed on a surface other than the lamination surface of the electrode body. Further, in the case where a plurality of tapes is wound around the outer periphery of each of the electrode bodies, it is preferable that the overlapping portions of all the tapes are disposed on the same surface of one of the surfaces other than the laminated surface of the electrode body.

In the battery cell stack, the positions of the overlapping portions of the tapes provided in the respective electrode bodies may be aligned in the stacking direction, or the positions of the overlapping portions may be separated without being aligned in the stacking direction.

For example, the positions of the overlapping portions of the tapes provided in the respective electrode bodies in the battery cell stack may be different from each other in the stacking direction in the stacking direction. By arranging the overlapping portions in a staggered pattern, large recesses are desired to be formed between the overlapping portions, and the occurrence of wrinkles in the laminate film is suppressed.
Further, for example, the positions of the overlapping portions of the tapes provided on the respective electrode bodies in the battery cell stack may be aligned in the stacking direction. Since the overlapping portions are aligned in the stacking direction, a large concave portion is easily formed between the overlapping portions, and when other components are arranged on the surface (for example, wiring, absorber, cooling plate, and the like), the overlapping portions are easily attached.

Next, a battery module, a battery pack, and a vehicle having a battery cell according to an embodiment of the present disclosure will be described with reference to the drawings.

### Overall Configuration of Vehicle 100

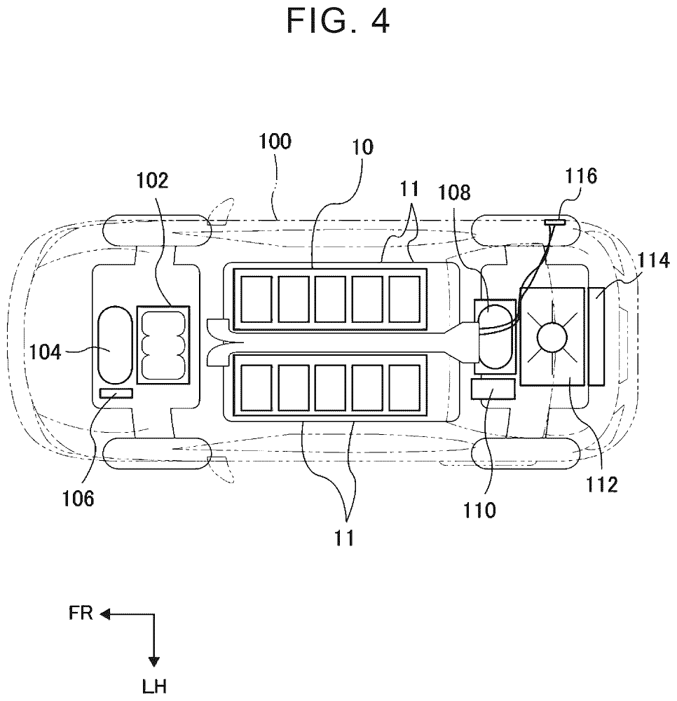

FIG. 4 is a schematic plan view showing a main part of a vehicle 100 to which the battery pack 10 according to the embodiment is applied. As illustrated in FIG. 4, the vehicles 100 are battery electric vehicle (BEV in which the battery packs 10 are mounted under the floor. Note that the arrows UP, the arrow FR, and the arrow LH in the drawings respectively indicate the upper side in the vehicle up-down direction, the front side in the vehicle front-rear direction, and the left side in the vehicle widthwise direction. In the case where the description is made using the front, rear, left, right, and up and down directions, the front and back directions in the vehicle front-rear direction, the left and right directions in the vehicle width direction, and the up and down directions in the vehicle vertical direction are shown unless otherwise specified.

In the vehicle 100 of the present embodiment, DC/DC converters 102, the electric compressors 104, and Positive Temperature Coefficient (PTC) heaters 106 are arranged in front of the vehicle relative to the battery pack 10. Further, a motor 108, a gear box 110, an inverter 112, and a charger 114 are disposed on the vehicle rear side of the battery pack 10.

The DC current outputted from the battery pack 10 is regulated by DC/DC converters 102 and then supplied to the electric compressor 104, PTC heaters 106, the inverters 112, and the like. Further, electric power is supplied to the motor 108 via the inverter 112, so that the rear wheels rotate to drive the vehicle 100.

A charging port 116 is provided on the right side portion of the rear portion of the vehicle 100, and electric power can be stored in the battery pack 10 via the in-vehicle charger 114 by connecting a charging plug of an external charging facility (not shown) from the charging port 116.

Note that the arrangement, structure, and the like of the components constituting the vehicle 100 are not limited to the above-described configurations. For example, it may be applied to an engine-mounted hybrid electric vehicle (HV) or plug-in hybrid electric vehicle (PHEV). Further, in the present embodiment, the motor 108 is a rear-wheel-driven vehicle mounted on the vehicle rear portion, but the present disclosure is not limited thereto, and the motor 108 may be a front-wheel-driven vehicle mounted on the vehicle front portion, or a pair of motors 108 may be mounted on the vehicle front and rear. Further, the vehicle may be provided with an in-wheel motor for each wheel.

Here, the battery pack 10 includes a plurality of battery modules 11. In the present embodiment, as an example, ten battery modules 11 are provided. Specifically, five battery modules 11 are arranged in the vehicle front-rear direction on the right side of the vehicle 100, and five battery modules 11 are arranged in the vehicle front-rear direction on the left side of the vehicle 100. The battery modules 11 are electrically connected to each other.

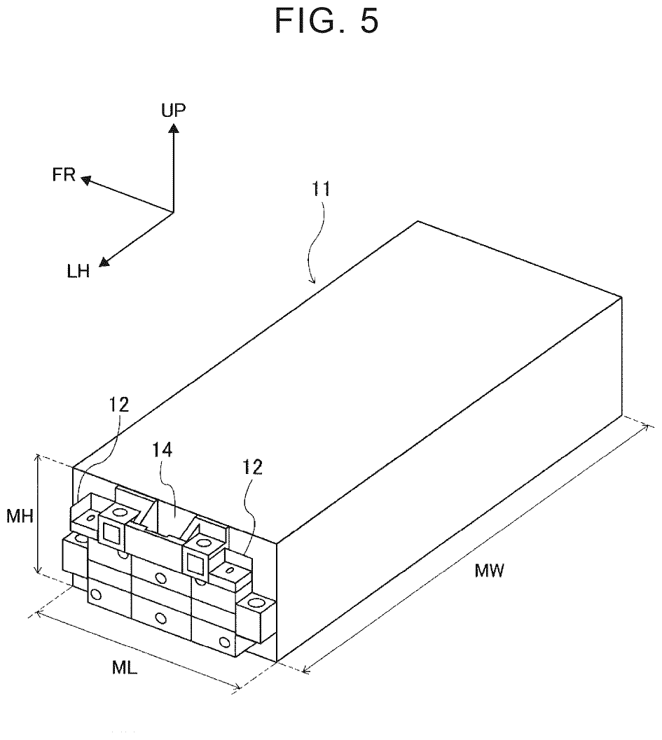

FIG. 5 is a schematic perspective view of the battery module 11. As shown in FIG. 5, the battery module 11 is formed in a substantially rectangular parallelepiped shape whose longitudinal direction is the vehicle width direction. The outer shell of the battery module 11 is made of an aluminum alloy. For example, an outer shell of the battery module 11 is formed by joining aluminum die-casting to both ends of an extruded material of an aluminum alloy by laser welding or the like.

A pair of voltage terminals 12 and a connector 14 are provided at both end portions of the battery module 11 in the vehicle width direction, respectively. A flexible printed circuit board 22, which will be described later, is connected to the connector 14. A bus bar (not shown) is welded to both end portions of the battery module 11 in the vehicle width direction.

The length MW of the battery module 11 in the vehicle width direction is, for example, 600 mm from 350 mm, the length ML in the vehicle front-rear direction is, for example, 250 mm from 150 mm, and the height MH in the vehicle vertical direction is, for example, 110 mm from 80 mm.

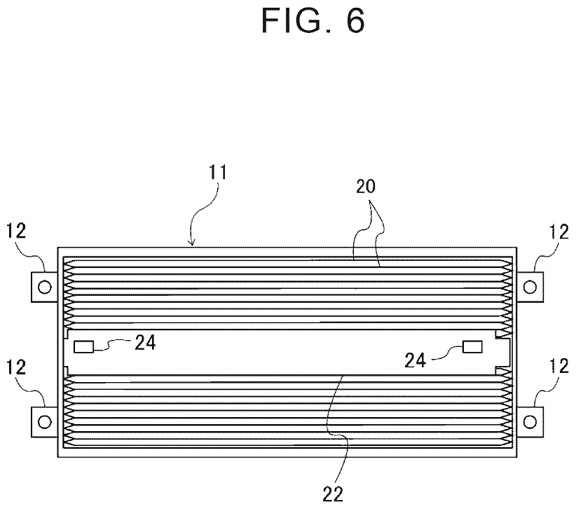

FIG. 6 is a plan view of the battery module 11 with the upper lid removed. As shown in FIG. 6, a plurality of battery cells 20 are accommodated in the battery module 11 in an arranged state. In the present embodiment, as an example, 24 battery cells 20 are arranged in the vehicle front-rear direction and adhered to each other.

A flexible printed circuit board Flexible Printed Circuit( ) 22 is disposed on the battery cell 20. The flexible printed circuit board 22 is formed in a band shape with the vehicle width direction as a longitudinal direction, and thermistors 24 are provided at both end portions of the flexible printed circuit board 22. The thermistor 24 is not adhered to the battery cell 20 and is pressed toward the battery cell 20 by the upper lid of the battery module 11.

One or a plurality of cushioning materials (not shown) are accommodated in the battery module 11. For example, the cushioning material is an elastically deformable thin plate-shaped member, and is disposed between the adjacent battery cells 20 with the arrangement direction of the battery cells 20 as the thickness direction. In the present embodiment, as an example, cushioning materials are disposed at both end portions in the longitudinal direction of the battery module 11 and at a central portion in the longitudinal direction, respectively.

FIG. 3 is a schematic view of the battery cell 20 accommodated in the battery module 11 as viewed from the thickness direction. As shown in FIG. 3, the battery cell 20 is formed in a substantially rectangular plate shape, and an electrode body (not shown) is accommodated therein. The electrode body is formed by laminating a cathode, an anode, and a separator, and is sealed with a laminate film 28.

In the present embodiment, as an example, the embossed sheet-like laminate film 28 is folded and bonded to form an accommodation portion of the electrode body. Although both of the single-cup embossing structure in which the embossing is performed at one place and the double-cup embossing structure in which the embossing is performed at two places can be adopted, in the present embodiment, the single-cup embossing structure has a 10 mm degree from the drawing depth 8 mm.

The upper ends of both end portions in the longitudinal direction of the battery cell 20 are bent, and the corners have an outer shape. Further, the upper end portion of the battery cell 20 is bent, and the fixing tape 30 is wound around the upper end portion of the battery cell 20 along the longitudinal direction.

Here, terminals (tabs) 26 are provided at both ends in the longitudinal direction of the battery cell 20. In the present embodiment, as an example, the terminal 26 is provided at a position offset downward from the center of the battery cell 20 in the vertical direction. The terminal 26 is joined to a bus bar (not shown) by laser welding or the like.

The vehicle-width-direction length CW1 of the battery cell 20 is, for example, from 530 mm to 600 mm, the length CW2 of the area in which the electrode body is accommodated is, for example, from 500 mm to 520 mm, and the height CH of the battery cell 20 is, for example, from 80 mm to 110 mm. The battery cell 20 has a thickness of 7.0 mm from 9.0 mm, and the height TH of the terminal 26 is 40 mm to 50 mm.

What is claimed is:

1. A battery cell, comprising:
an electrode body, in which is stacked a plurality of laminated structures, each of the laminated structures including a cathode, an anode, and a separator interposed between the cathode and the anode; and
tape that is wound one round around an outer perimeter of the electrode body and applied, wherein
the tape includes an overlapping portion at which one end side and another end side in an outer perimeter direction overlap, and
with a direction in which the laminated structures are stacked in the electrode body as a stacking direction, and an end face in the stacking direction in the electrode body as a stacking face, the overlapping portion is disposed on a face of the electrode body other than the stacking face.

2. The battery cell according to claim 1, wherein
a plurality of pieces of the tape is wound and applied to the outer perimeter of the electrode body, and
the overlapping portions of all of the pieces of tape are disposed on a face of the electrode body other than the stacking face.

3. The battery cell according to claim 2, wherein the overlapping portions of all of the pieces of tape are disposed on a same one face of the faces of the electrode body, other than the stacking face.

4. A battery cell stack, comprising a plurality of the battery cells according to claim 1, stacked in the stacking direction.
